(19) United States
(12) Patent Application Publication
(10) Pub. No.: US 2023/0012251 A1
(43) Pub. Date: Jan. 12, 2023

(54) RETROFITTABLE AND NEW-INSTALLATION IN-FLIGHT WIRELESS MESH NETWORK DRAWING POWER FROM AIRPLANE SEAT ELECTRONICS BOX

(71) Applicant: MINIME-LABS GLOBAL, INC., Austin, TX (US)

(72) Inventor: Constantinos Demetriou, Limassol (CY)

(21) Appl. No.: 17/704,673

(22) Filed: Mar. 25, 2022

Related U.S. Application Data
(60) Provisional application No. 63/140,974, filed on Jan. 25, 2021.

(51) Int. Cl. H04W 84/12; H04N 21/214; H04N 21/414

(52) U.S. Cl. CPC H04W 84/12; H04N 21/2146; H04N 21/41422

(57) ABSTRACT

In-flight wireless network systems and solutions are described. According to an embodiment, the in-flight wireless network system includes a wireless router connected to one or more in-flight media servers of an aircraft and to an onboard high-speed wireless communication transceiver module. The system includes one or more strategically located wireless access points installed across the passenger cabin of the aircraft to provide connectivity to user devices and inflight data nodes, wherein each of the one or more wireless access points is powered from preinstalled Seat Electronic Box (SEB). SEBs already placed near each seat include a power supply, which can be used to power the access points.

The present application claims the benefit of U.S. Provisional Application No. 63/140,974, filed Jan. 25, 2021; all of which is incorporated herein by reference.

### FIELD OF THE DISCLOSURE

Embodiments of the present disclosure relate to an in-flight wireless network. In particular, embodiments of the present invention relate to wireless access points drawing power from seat electronics boxes to provide an in-flight wireless network.

### BACKGROUND OF THE DISCLOSURE

In-flight entertainment (IFE) systems are deployed in aircraft to provide entertainment services for passengers on their seat screen. Most of the aircraft, specially mid-haul aircraft and long-haul aircraft, have IFE systems. The IFE systems typically provide passengers with television and audio multimedia entertainment programming.

IFE systems may use a server-centric architecture or seat-centric architecture. In a server-centric architecture, multimedia contents are stored on a server or a set of servers installed in the electronic bay of the aircraft. Passengers can browse and consume content from the media server through the seat screen. In seat-centric architecture, multimedia contents are stored in mass data storage devices located at individual seats. Passengers can browse and consume content from the local data storage through the seat screen. In seat-centric architecture, the server (or set of servers) acts as an injection point for content that will be later installed locally into the seat mass data storage devices and also acts as a secondary source for content that may not fit in the mass data storage devices associated with the seats.

There has also been an emergence of wireless systems providing connectivity to passenger devices (i.e., Internet access) as well as limited streaming entertainment (i.e., movies). As lifestyle and business requirements are changing, the Internet is becoming an integral part of our life.

Passengers want to stay connected even during the flight. The needs of passengers to be able to access media content on their personal devices and be able to connect to the Internet are creating requirements for airliners to install wireless access points within the cabin. Some existing solutions have access points installed in the ceiling of the aircraft.

An example is disclosed in a U.S. Pat. No. 9,490,891 titled “Technique for In-flight Connectivity” (“the '891 Patent”). The ′891 Patent talks about a hybrid in-flight communications system that integrates aircraft communications systems and traffic management of the aircraft air-to-ground communications and satellite communications to provide gate-to-gate connectivity to users on an aircraft. The patent ′891 describes a technique for providing users with in-flight connectivity through an apparatus for communications on an aircraft using the equipment. The equipment includes a modem configured to process signals communicated with a non-terrestrial relay point. The first equipment includes a second modem configured to process signals communicated with a terrestrial relay point. The apparatus includes a wireless local area access node configured to communicate with user equipment on the aircraft and a small cell access node configured to communicate with user equipment on the aircraft.

Another example is disclosed in a U.S. Pat. No. 9,462,300 titled “Distributed Seat Centric Wireless In-flight Entertainment System” (“the '300 Patent”). The '300 patent describes an entertainment system that includes a plurality of wireless access points. Each wireless access point includes a mass memory, at least one radio transceiver, and at least one processor. The radio transceiver is configured to communicate with seat display devices and to communicate with the personal electronic devices of users. The processor is configured to receive entertainment content, which includes a plurality of content items, through at least one radio transceiver, and to store the entertainment content in the mass memory. The processor downloads the entertainment content using a file transfer protocol from the mass memory to the seat display devices through at least one radio transceiver and streams the content items of the entertainment content using a streaming protocol from the mass memory to the personal electronic devices of users through the at least one radio transceiver. The access points of ′300 would be bulky equipment.

These solutions are very costly as it requires aircraft to be grounded for a number of days in addition to the costly hard equipment. It has also been observed that the ceiling based access points face signal issues due to the presence of metallic structure in the ceiling. For Installing new additional electronic or communication devices (e.g., access points), aircraft needs to be grounded for some time and as one will appreciate, grounding a passenger aircraft is a direct loss for the airline company. For installation of any new component, airliners need to consider the availability of equipment bay space, electrical power points, weight, and cost associates with a new installation.

Therefore, there is a need for a system that can provide an easy, efficient, and retrofittable solution to provide a wireless connection to user devices and seat screen to connect to the in-flight entertainment system and the Internet.

### SUMMARY

In-flight wireless network systems and solutions are described. According to an embodiment, an in-flight wireless mesh network system includes a wireless router and one or more strategically located wireless access points installed across the passenger cabin of the aircraft to provide connectivity to user devices and inflight data nodes. The wireless router is connected to one or more in-flight media servers of an aircraft and to an onboard high-speed wireless communication transceiver module to provide, for example, in-flight entertainment, deliver content, facilitate e-commerce transaction (e.g., ordering of food and beverages, etc.). Each of the one or more wireless access points of the system is powered by a preinstalled Seat Electronic Box (SEB). SEBs already placed near each seat include a power supply, which can be used to power the access points.

In an embodiment, an access point of the system is a retrofittable component that can be plugged into the power outlet of the SEB. The access points can be fitted underneath the seat or on the wall of the aircraft beneath the wall covering. The access points can be fitted next to the arm of the window seat. In an embodiment, the access point of the system can be placed during line-fitting while placing the seats. The access point may include any or combination of 2.4 GHz and 5 GHz antennas to provide wireless signals to passenger devices and to inflight data nodes (e.g., CO2 sensors, Oxygen sensors, IoT devices, etc.). In an embodiment, the access point is integrated with plug and play USB device or a power plug socket. The access points can be integrated with any other type of form factors. As one will appreciate, the access point is designed to draw power from the SEB, and hence, requires minimal grounding of the aircraft. The proposed system provides an efficient solution for adding in-flight entertainment solutions and extending high-speed internet connection to passenger devices even during the flight.

Depending on the layout of the passenger cabin, the location of each of the one or more access points can be determined so as to provide full coverage and minimal interference with optimal speed to all passengers. In an example implementation, a wireless router can be placed somewhere in the middle of the aircraft, and an access point placed in each diagonally opposite seat row. For example, an access point can be placed in the first row on the left side of the aisle, and a second access point can be placed on the right-hand side in the second row, and so on. The density of the access points may also differ depending on passenger density. For example, more access points can be added in the economy zone per square foot as compared to a business class zone.

In some embodiment, the wireless router may be connected to media servers and the onboard high-speed wireless communication transceiver module through an ethernet cable or wireless connection. The onboard wireless communication transceiver module is configured to provide air to ground communication for internet connection and/or satellite-based internet connection. Depending on the layout of the aircraft, one or a mesh network can be created. In a multi-network scenario (multiple mesh networks) media server can be connected to each of the networks. In some implementations, a dedicated mesh network can be created to provide connectivity and media streaming services to passenger devices, and a separate mesh network can be created to connect data nodes, such as sensors requires for the safety and operational purposes of the aircraft.

In an embodiment, the wireless router is configured to receive PA signal from the public announcement (PA) system of the aircraft and redirect PA signal to passenger devices. In some embodiment, the wireless router on receiving a PA pause signal may pause all communication if rules of the operating airport require so. The wireless router can be configured to determine the PA signal category and pause passenger data traffic based on the PA signal category. In an embodiment, the wireless mesh network system is configured to receive interrupt signals from the aircraft cockpit or from the PA system and apply associated rules to control data traffic to/from the passenger device and display device of the seat.

Other features of embodiments of the present disclosure will be apparent from the accompanying drawings and detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates an example media server of an in-flight entertainment system used in accordance with an embodiment of the present disclosure.

FIG. 2 illustrates an example In-Seat Power Supply (ISPS) used in accordance with an embodiment of the present disclosure.

FIG. 3 illustrates example functional blocks of a wireless mesh network system in accordance with an embodiment of the present disclosure.

FIG. 4 illustrates an example installation of Seat Electronic Box (SEB) installation that is used power access node in accordance with an embodiment of the present disclosure.

FIG. 5 illustrates an example SEB with four Universal Serial Bus (USBs) that can be used in accordance with an embodiment of the present disclosure.

FIG. 6 illustrates an example cabin layout and installation of access points of a wireless mesh network in accordance with an embodiment of the present disclosure.

FIG. 7 illustrates an exemplary computer system in which or with which embodiments of the present disclosure may be utilized.

### DETAILED DESCRIPTION OF THE DISCLOSURE

Described here is an in-flight wireless network system providing connectivity to passenger devices and other data nodes in the passenger cabin. The wireless network system can be a wireless mesh system, for example. The in-flight wireless network system includes a wireless router and or more plug and play(PnP)wireless access points (also referred to as wireless nodes) placed inside the passenger cabin of an aircraft. In-seat power available at seat electronic box is used to power access points. As one will appreciate, the proposed system piggyback on available seat power to power access points and other components.

The detailed description set forth below in connection with the appended drawings is intended as a description of exemplary embodiments in which the presently disclosed process can be practiced. The term “exemplary” used throughout this description means “serving as an example, instance, or illustration” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form to avoid obscuring the concepts of the presently disclosed method and system.

Embodiments of the present invention include various steps, which will be described below. The steps may be performed by hardware components or may be embodied in machine-executable instructions, which may be used to cause a general-purpose or special-purpose processor programmed with the instructions to perform the steps.

Embodiments of the present invention may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within the single computer) and storage systems containing or having network access to a computer program(s) coded in accordance with various methods described herein, and the method steps of the invention could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

According to an embodiment, an in-flight wireless mesh network system includes a wireless router connected to one or more in-flight media servers of an aircraft and to an onboard high-speed wireless communication transceiver module. The system includes one or more strategically located wireless access points installed across the passenger cabin of the aircraft to provide connectivity to user devices and inflight data nodes, wherein each of the one or more wireless access points is powered from preinstalled Seat Electronic Box (SEB). SEBs already placed near each seat include a power supply, which can be used to power the access points.

In an embodiment, an access point of the system is a retrofittable component that can be plugged into the power outlet of the SEB. The access points can be fitted underneath the seat, on the wall of the aircraft. The access points can be fitted next to the arm of the window seat. In an embodiment, the access point of the system can be placed during line-fitting while placing the seats. The access point may include any or combination of 2.4 GHz and 5 GHz antennas to provide wireless signals to passenger devices and to inflight data nodes (e.g., CO2 sensors, Oxygen sensors, IoT devices, etc.). In an embodiment, the access point is integrated with plug and play USB device or a power plug socket. The access points can be integrated with any other type of form factors. As one will appreciate, the access point is designed to draw power from the SEB, and hence, requires minimal grounding and are is an efficient solution for adding in-flight entertainment solution and providing high-speed internet connection.

Although the description with FIGS. illustrates one SEB for each seat in an embodiment, the scope of the disclosure includes an arrangement where a SEB can power electronic components of three or more seats. In such a configuration, one or more access points can be powered from a single SEB. The wireless access point of the mesh network can be powered from the nearest SEB. There may be other wiring and electrical arrangements to bring power to seats from the floor of the aircraft. The Access point is designed to be plugged into a power source coming to a seat. As one will appreciate, the wireless access point covers any other alternative design that draws power from the in-seat power supply (ISPS) junction box. The access point can draw power from the USB port or any other power source available in and around the seat and doesn't require a separate power connection from the power supply cabin to the passenger cabin.

The PnP access points having embedded software can self recognize the wireless router and configured themselves for that. The self-configuration, however, in some embodiment, can be disabled.

In some embodiment, an Ethernet cable can be put in place parallel to the electrical lines to connect the wifi-router with one or more access points.

The access point may provide WLAN, Bluetooth, ZigBee, NFC support. The access point is configured to operate at 2.4 GHz, 5 GHz frequency and can be configured to operate at any other frequency recommended for a wireless mesh network. The access point may provide support for IEE 802.11 a/b/g/n, IEEE 802.15.4, IEEE 802.11ad protocols, and other 4G and 5G standards. In an embodiment, the access point can be integrated with a retrofittable power supply kit.

The wireless router connected with the IFE system and access points enables a wireless mesh network and provides connectivity to passenger devices. The Mesh network is supposed to provide bandwidth up to Gigabit per second and more.

Depending on the layout of the passenger cabin, the location of each of the one or more access points can be determined so as to provide full coverage and minimal interference with optimal speed to all passengers. In an example implementation, a wireless router can be placed somewhere in the middle of the aircraft, and each diagonally opposite seat row may have an access point. For example, an access point can be placed in the first row on the left side, and a second access point can be placed on the right-hand side in the second row, and so on. The density of the access points may also differ depending on passenger density. For example, more access points can be added in the economy zone per square foot as compared to the business class zone.

In some embodiment, the wireless router may be connected to media servers and the onboard high-speed wireless communication transceiver module through an ethernet cable or wireless connection. The onboard wireless communication transceiver module is configured to provide air to ground communication for internet connection and/or satellite-based internet connection. Depending on the layout of the aircraft, one or a mesh network can be created. In a multi-network scenario (multiple mesh networks) media server can be connected to each of the networks. In some implementations, a dedicated mesh network can be created to provide connectivity and media streaming services to passenger devices, and a separate mesh network can be created to connect data nodes, such as sensors requires for safety and operational purposes.

In an embodiment, the wireless router is configured to receive the PA signal from the public announcement (PA) system of the aircraft and redirect the PA signal to the passenger device. In some embodiment, the wireless router on receiving a PA pause signal may pause all communication if rules of the operating airport require so. In an embodiment, the wireless router can be configured to determine the PA signal category and pause passenger data traffic based on the PA signal category. In an embodiment, the wireless mesh network system is configured to receive interrupt signals from the aircraft cockpit or from the PA system and apply associated rules to control data traffic to/from the passenger device and display device of the seat.

In some embodiment, the wireless mesh network may provide connectivity to one or more sensors, for example, CO2 sensor, oxygen concentration detection sensor, etc. used for flight safety and operational purposes—embodiments of the disclosure envision plug-and-play safety sensors powered by SEB junction box.

The in-flight wireless mesh network system includes a wireless router that may be connected or integrated with a media server and or more access points drawing power from In-Seat Power Supply (ISPS).

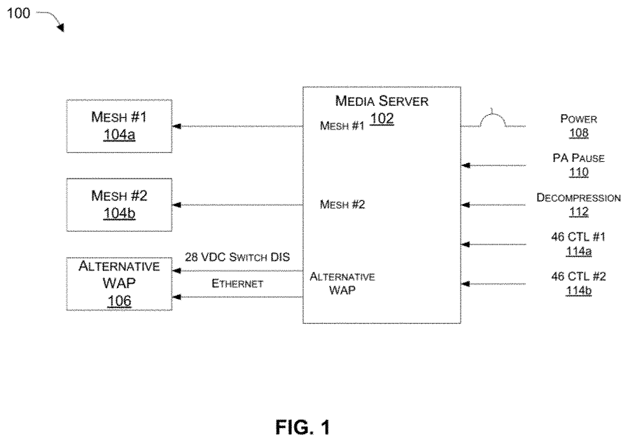

FIG. 1 illustrates an example media server of an in-flight entertainment system used in accordance with an embodiment of the present disclosure. An onboard media server 102 is configured to store media content and provide the media content to passenger devices and seat screens through a wireless mesh network. The media server 102 can video audio and video audio, allow the passenger to explore a map, and play games, perform in-flight e-commerce, and others explore any other content permissible content. The media server 102 may have a wireless router integrated with it to provide wireless access of different contents to passenger devices and to seat screens. The media server 102 is configured to support one or more media streaming protocols, such as MPEG-DASH, Apple HTTP Live Streaming (HLS), Microsoft Smooth Streaming, and Adobe HTTP Dynamic Flash Streaming (HDS. Video streaming protocols, such as Real-Time Messaging Protocol (RTMP), Web Real-time Communication Protocol (WebRTC), Faster Than Light Protocol (FTL), and Secure Reliable Transport (SRT), can also be supported by the media server 102. The media server 102 receives power 108 from the aircraft power line assembly. In an embodiment, the media server 108 may draw power 108 from the In-Seat Power Supply (ISPS) line. The media server can be accessed from one or more wireless mesh networks, such as mesh-1 104a and mesh-2 104b. In some embodiment, each network of the one or more wireless mesh network may have dedicated bandwidth allocated to it. The media server 102 can be configured to be connected to an alternative WAP 106.

In compliance with the safety standards, the media server 102 on reiving PA pause 110 commands may pause media streaming services and broadcast a PA message to all connected devices. The media server 102 may broadcast the PA message, which can be played on the passenger devices as well to the seat screens. The media server 102 may also receive other signals and commands, such as decompression signal 112, CTL-1 114a, and CTL-2 114b, and take appropriate actions, such as pause all media steaming, broadcasting a relevant message, etc. A wireless router, when implemented as a separate device, can also be configured to be responsive to PA messages and other control signals. Similar to the media server 102, the wireless router of the mesh network system can also pause all data traffic to gain passengers (also referred to as users) attention.

In an embodiment, the media server 102 integrated with wireless router functionality can be a portable and compact battery-operated device. The portable media server 102 may not require STC clearance as no cables or screw is necessary.

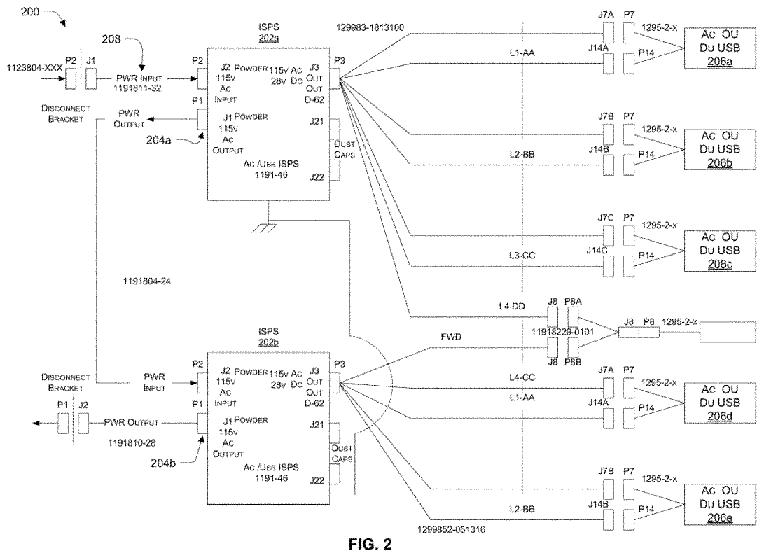

FIG. 2 illustrates an example In-Seat Power Supply (ISPS) used in accordance with an embodiment of the present disclosure. As shown in FIG. 2, power output 204a and power output 204b of ISPS 202a and ISPS 202b, respectively, is used to power wireless access points of the in-flight wireless mesh network. In some embodiments, CU USB port 206a-e can be used to power the wireless access points of the mesh network. The ISP's power input (e.g., 115V AC input 208) from the electronic control room of the aircraft and may provide 28V DC Output or 115 VAC output, which is used to power the wireless access point. The ISPS 202 intelligently converts and manages 28 V DC or 110 V Ac to multiple outputs of 110 V Ac/60 Hz and provides 28 V DC for USB ports. One ISPS (e.g., ISPS 202a) can power any combination of a number of AC and USB outlets. Depending on the format factor chosen, the access points can be powered either by USB ports or through AC output. As the preinstalled ISPS, which already have safety features, is used to power access points, the installation of a wireless mesh network becomes faster and easier. The ISPS can be used to provide charging to portable electronic devices of passengers and crew. The ISPS may convert and manage 28 VDC to up to 175 VA to each outlet. The ISPS may be covert and manage 28 VDC to multiple outlets of 115 VAC. 60 Hz and provide 28 VDC for USB. Output 115 VAC output can be used to power another ISPS as well.

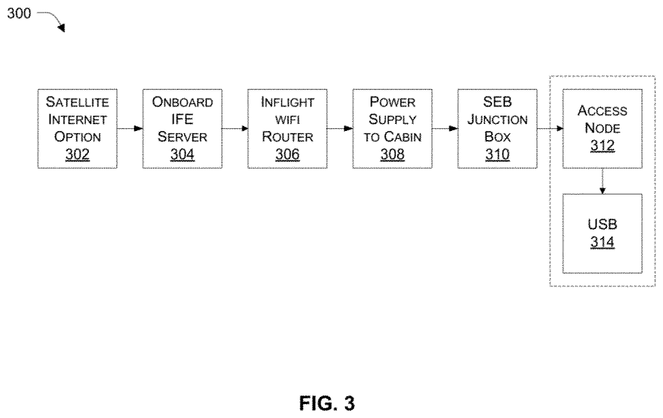

FIG. 3 illustrates example functional blocks of a wireless network system in accordance with an embodiment of the present disclosure. In some embodiments, the wireless network may be a retrofittable or line-fitted solution. The wireless network includes a wireless mesh network. The wireless network system, designed to provide in-flight entertainment and/or provide internet connectivity to passengers on passenger devices or seat screens, connects to satellite internet option 302 and an onboard IFE server 304. The inflight wireless router 306 can be connected to or can be integrated with the onboard IFE server 304. The router can facilitate passenger devices connecting through access point 312 to stream media content, order food & beverages, read e-magazines, play games, view maps, flight information, etc., from the IFE server 304. The IFE server 304 may be connected to the Internet through satellite internet option 302 or to a high-speed in-flight transceiver that provides air to ground connectivity. The wireless router 306 can be powered through the same power outlet that is used to power the IFE server 306. Preinstalled power supply to cabin 308 powers SEB junction box 310. An access node 312 (also referred to as access point) developed a form factor available with USB 314 output that can be powered by the output of the SEB junction box 310. In an embodiment, the access node 312 can be developed in other form factors, which may have an AC input circuit that can be plugged into the power output socket of the SEB junction box 310.

The wireless mesh network system may allow the user to access the Internet through satellite internet option 302 or using a wireless transceiver module connecting the aircraft using air-ground communication links. The wireless mesh network system may use the Ku band or KA band to provide satellite-based based internet connection to in-flight wireless devices.

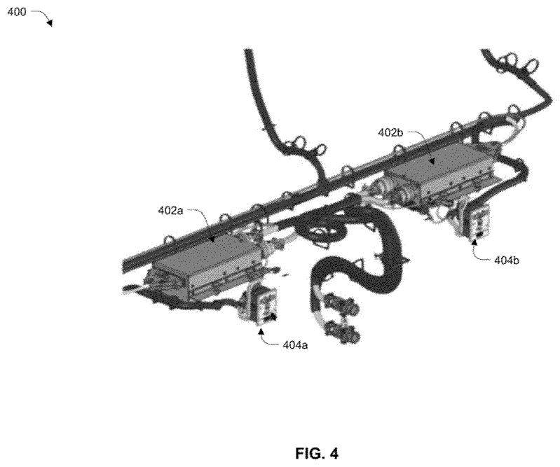

FIG. 4 illustrates an example installation of Seat Electronic Box (SEB) installation that is used power access node in accordance with an embodiment of the present disclosure. As shown in FIG. 4, power output socket 404a and socket 404b of SEB 402a and SEB 402, respectively, can be used to plug the PnP wireless access point. Although FIG. 4 illustrates one SEB for each seat, the newer generation SEBs can power three and more seats. One output power socket of the SEB can be used to connect the PnP access point.

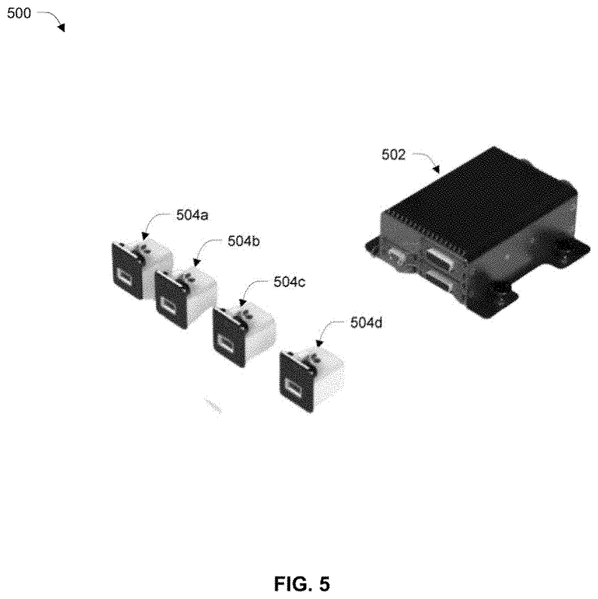

FIG. 5 illustrates an example SEB with four Universal Serial Bus (USBs) that can be used in accordance with an embodiment of the present disclosure. A SEB 502 may have provided to provide power to many USB ports (e.g., USB ports)). An access point in the form of the USB pluggable device can connect to a USB port of the SEB 502 and user 28 VDC to power the access point circuit.

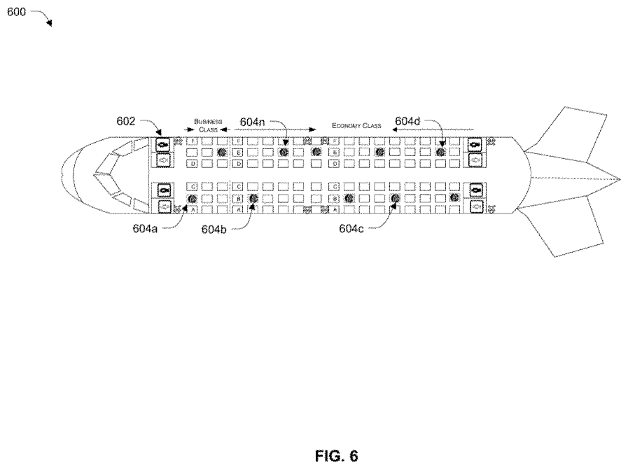

FIG. 6 illustrates an example cabin layout and installation of access points of a wireless mesh network in accordance with an embodiment of the present disclosure. Multiple access points can be placed at different strategic locations within the passenger cabin 602 to provide better connectivity to all passengers. A number of access points to be placed and the location of each of the access points can be determined based on the layout of the passenger cabin. In an example implementation, access points 604a-n can be placed distributed manner, as shown in FIG. 6. An access point can be added to the middle seat of 4th alternative rows in and zig-zag manner so as to avoid interferences and provide maximum coverage. Access points can be placed with each diagonally opposite middle seat of alternate seating rows.

In an embodiment, a wireless access point that can be fitted in a retrofittable plug-and-play form factor designed to draw power from SEB in accordance with an embodiment of the present disclosure. The wireless access point is designed as a PnP device. In an embodiment, the wireless access point can be in the form of a PnP USB device that can be plugged into a USB port powered by the SEB. In an alternative implementation, the wireless access point can come with a two-pin power input circuit that powers the access point when plugged into the AC power output of the SEB. The wireless access point is configured to support 4G and 5G communication protocols and provide support for ZigBee, Bluetooth, NFC protocols.

The in-flight wireless mesh network system provides a local network in which the infrastructure nodes (i.e., bridges, switches, and other infrastructure devices) connect directly, dynamically, and non-hierarchically to as many other nodes as possible and cooperate with one another to efficiently route data from/to clients. This lack of dependency on one node allows for every node to participate in the relay of information. Mesh networks dynamically self-organize and self-configure, which can reduce installation overhead. The ability to self-configure enables the dynamic distribution of workloads, particularly in the event a few nodes should fail. This, in turn, contributes to fault-tolerance and reduced maintenance costs.

Mesh topology may be contrasted with conventional star/tree local network topologies in which the router/bridges/switches are directly linked to only a small subset of another communication module/bridges/switches, and the links between these infrastructure neighbors are hierarchical.

The wireless mesh network system may have a one or more mesh network, wherein one mesh network of the access points can be configured to allow passengers devices to be connected, while a second mesh network can be configured to disallow data traffic from passenger device and can be used only transmitting signal related to flight safety and operations.

As one will appreciate, the wireless network system can be created in a similar manner for any passenger transportation mode. For example, a similar system can be put in place for the railway, bus, drone, cable car, cruise, etc.

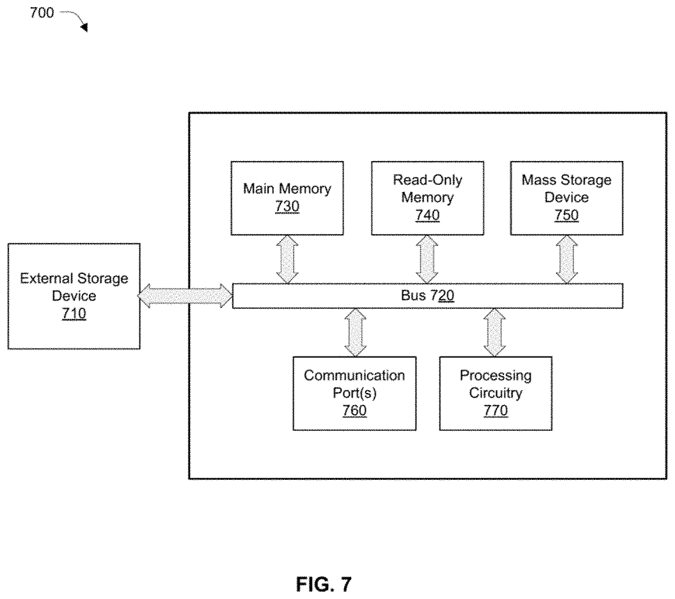

The wireless router of the in-flight wireless mesh network system can be configured on a computer system, as shown in FIG. 7. FIG. 7 illustrates an exemplary computer system in which or with which embodiments of the present disclosure may be utilized. Depending upon the particular implementation, the various process and decision blocks described above may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction. As shown in FIG. 7, the computer system includes an external storage device 710, a bus 720, a main memory 730, a read-only memory 740, a mass storage device 750, a communication port 760, and a processor 770.

Those skilled in the art will appreciate that computer system 700 may include more than one processing circuitry 770 and communication ports 760. The processing circuitry 770 should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quadcore, Hexa-core, or any suitable number of cores) or supercomputer. In some embodiments, processing circuitry 770 is distributed across multiple separate processors or processing units, for example, multiple of the same type of processing units (e.g., two Intel Core i7 processors) or multiple different processors (e.g., an Intel Core i5 processor and an Intel Core i7 processor). Examples of processing circuitry 770 include, but are not limited to, an Intel® Itanium® or Itanium 2 processor(s), or AMD® Opteron® or Athlon MP® processor(s), Motorola® lines of processors, System on Chip (SoC) processors, or other future processors. Processing circuitry 770 may include various modules associated with embodiments of the present invention.

Communication port 760 may include a cable modem, Integrated Services Digital Network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. The communication port 760 can be any of an RS-232 port for use with a modem-based dialup connection, a 10/100 Ethernet port, a Gigabit or 10 Gigabit port using copper or fiber, a serial port, a parallel port, or other existing or future ports. Communication port 760 may be chosen depending on a network, such as a Local Area Network (LAN), Wide Area Network (WAN), or any network to which the computer system connects.

Memory 730 may include Random Access Memory (RAM) or any other dynamic storage device commonly known in the art. Read-only memory 740 can be any static storage device(s), e.g., but not limited to, a Programmable Read-Only Memory (PROM) chips for storing static information, e.g., start-up or BIOS instructions for processing circuitry 770.

Mass storage 750 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) 10 recorders, BLU-RAY 3D disc recorders, digital video recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement storage memory in 730. Memory 750 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Desk star 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

Bus 720 communicatively connects processor(s) 770 with the other memory, storage, and communication blocks. Bus 720 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 770 to a software system.

Optionally, operator and administrative interfaces, e.g., a display, keyboard, and a cursor control device, may also be coupled to bus 720 to support direct operator interaction with the computer system. Other operator and administrative interfaces can be provided through network connections connected through communication port 760. An external storage device 710 can be any kind of external hard-drives, floppy drives, IOMEGA® Zip Drives, Compact Disc—Read-Only Memory (CD-ROM), Compact Disc—Re-Writable (CD-RW), Digital Video Disk—Read Only Memory (DVD-ROM). The components described above are meant only to exemplify various possibilities. In no way should the aforementioned exemplary computer system limit the scope of the present disclosure.

The computer system 700 may be accessed through a user interface. The user interface application may be implemented using any suitable architecture. For example, it may be a stand-alone application wholly implemented on the computer system 700. The user interface application and/or any instructions for performing any of the embodiments discussed herein may be encoded on computer-readable media. Computer-readable media includes any media capable of storing data. In some embodiments, the user interface application is a client server-based application. Data for use by a thick or thin client implemented on an electronic device computer system 700 is retrieved on-demand by issuing requests to a server remote to the computer system 700. For example, computing device 700 may receive inputs from the user via an input interface and transmit those inputs to the remote server for processing and generating the corresponding outputs. The generated output is then transmitted to the computer device 700 for presentation to the user.

While embodiments of the present invention have been illustrated and described, it will be clear that the invention is not limited to these embodiments only. Numerous modifications, changes, variations, substitutions, and equivalents, will be apparent to those skilled in the art without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, the terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter outlined in the claims is not intended to be limited to the embodiments shown herein but is to be accorded to the widest scope consistent with the principles and novel features disclosed herein. It is contemplated that additional embodiments are within the spirit and true scope of the disclosed subject matter.

What is claimed is:

1. I claim all of the above subject matter.
